(19) United States
(12) Patent Application Publication
(10) Pub. No.: US 2021/0150254 A1
(43) Pub. Date: May 20, 2021

(54) TRACKING CONTROL METHOD, APPARATUS, AND COMPUTER-READABLE STORAGE MEDIUM

(71) Applicant: SZ DJI TECHNOLOGY CO., LTD., Shenzhen (CN)

(72) Inventors: Pan HU, Shenzhen (CN); Wen ZOU, Shenzhen (CN); Hongyong ZHENG, Shenzhen (CN)

(21) Appl. No.: 17/158,713

(22) Filed: Jan. 26, 2021

Related U.S. Application Data
(63) Continuation of application No. PCT/CN2018/097667, filed on Jul. 27, 2018.

(51) Int. Cl. G06K 9/62; G06N 3/08; G06K 9/00; G06N 3/04

(52) U.S. Cl. CPC G06K 9/626; G06N 3/08; G06N 3/0454; G06K 9/6256; G06K 9/00228

(57) ABSTRACT

The present disclosure provides a tracking control method. The method includes obtaining an input image sequence; based on a detection algorithm, detecting a frame of input image in the input image sequence to obtain a tracking frame including a target object; and based on a tracking algorithm, tracking the target object in a plurality of frames of input images behind the frame of input image based on the tracking frame of the target object.

### CROSS-REFERENCE TO RELATED APPLICATION

This application is a continuation of International Application No. PCT/CN2018/097667, filed on Jul. 27, 2018, the entire content of which is incorporated herein by reference.

### TECHNICAL FIELD

The present disclosure relates to the field of electronic information technology and, more specifically, to a tracking control method, a tracking control apparatus, and a computer-readable storage medium.

### BACKGROUND

The face detection methods in conventional technology include cascade classifier detection methods, deformable parts models (DPM) detection methods, etc. However, the reliability and accuracy of these face detection methods are relatively poor. Therefore, with the improvements of convolutional neural network (CNN), more and more CNN-based face detection methods are being examined.

CNN-based face detection methods are generally trained and run on servers with high-performance graphics processing unit (GPU) and high-performance central processing unit (CPU). The trained network can have defects such as complex network, too many layers, too many parameters, and large memory overhead, which leads to complex calculation processes and cannot achieve real-time detection.

### SUMMARY

One aspect of the present disclosure provides a tracking control method. The method includes obtaining an input image sequence; based on a detection algorithm, detecting a frame of input image in the input image sequence to obtain a tracking frame including a target object; and based on a tracking algorithm, tracking the target object in a plurality of frames of input images behind the frame of input image based on the tracking frame of the target object.

Another aspect of the present disclosure provides a tracking control apparatus. The apparatus includes a processor; and a memory storing one or more sets of instruction sets that, when executed by the processor, causes the processor to: obtain an input image sequence; based on a detection algorithm, detect a frame of input image in the input image sequence to obtain a tracking frame including a target object; and based on a tracking algorithm, track the target object in a plurality of frames of input images behind the frame of input image based on the tracking frame of the target object.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a flowchart of a tracking method according to an embodiment of the present disclosure.

FIG. 2 is a schematic diagram of a simplified MTCNN according to an embodiment of the present disclosure.

FIG. 3A is a schematic diagram of a state machine and synchronization mechanism of a detection algorithm according to an embodiment of the present disclosure.

FIG. 3B is a schematic diagram of a state machine and synchronization mechanism of a tracking algorithm according to an embodiment of the present disclosure.

FIG. 4 is a schematic structural diagram of a tracking control apparatus according to an embodiment of the present disclosure.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

The terms used in the present disclosure are only for the purpose of describing specific embodiments, and are not for limiting the present disclosure. The singular forms “a,” “an,” and “the” are intended to include the plural forms as well, unless the context indicates otherwise. The term “and/or” used herein includes any suitable combination of one or more related items listed.

Although the present disclosure may use terms such as “first,” “second,” “third,” etc., to describe various information, the information is not limited by these terms. The terms are only used to separate the information of the same type. For example, without departing from the scope of the present disclosure, the first information may also be referred to as the second information. Similarly, the second information may be referred to as the first information. Depending on the context, the term “if” may be interpreted as “when,” or “as,” or “in response to.”

The present disclosure provides a tracking method. The method can be applied to a tracking control device, such as a mobile platform, etc., where the mobile platform may include, but is not limited to, an unmanned aerial vehicle (UAV) and a ground robot (such as an unmanned vehicle, etc.). Further, the mobile platform may be equipped with an imaging device (e.g., a camera, a video camera, etc.) and capture images through the imaging device. In addition, the mobile platform may also be equipped with a gimbal, and the gimbal may carry the imaging device for stabilization and/or adjustment of the imaging device.

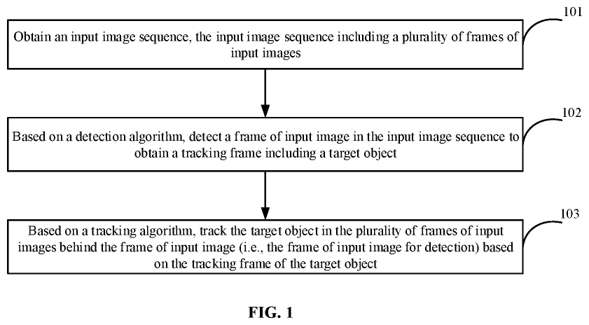

Referring to FIG. 1, which is a flowchart of a tracking method. The method will be described in detail below.

101, obtaining an input image sequence, which may include a plurality of frames of input images.

The input image sequence may be input images of consecutive frames in the video data.

More specifically, the execution body of the method may be a mobile platform, such as a processor of a mobile platform. One or more processors may be used, and the processor may be a general-purpose processor or a dedicated processor.

As described above, the mobile platform may be equipped with an imaging device. In the process of the mobile platform tracking a target, the imaging device may capture image of the target object to obtain an image, and the processor of the mobile platform may obtain the captured image, where each captured image may be a frame of the input image, and a collection of a plurality of frames of input images may be used as the input image sequence.

In some embodiments, the target object may be an object tracked by the mobile platform.

In some embodiments, the input image may include at least a target object, and the target object may include a human face.

102, based on a detection algorithm, detecting a frame of input image in the input image sequence to obtain a tracking frame including a target object. Based on the detection algorithm, one frame of the input image in the input image sequence (such as the first frame of the input image in the input image sequence) can be detected, instead of detecting each frame of the input image in the input image sequence based on the detection algorithm.

In one example, based on the detection algorithm, detecting a frame of input image in the input image sequence to obtain the tracking frame including the target object may include using a specific CNN detection algorithm to detect a frame of input image in the input image sequence to obtain the tracking frame including the target object, where the specific CNN detection algorithm may include, but is not limited to, a weak classifier. For example, the specific CNN detection algorithm may be a multi-task convolutional neural network (MTCNN) detection algorithm including pnet and met, but not including onet.

For example, the specific CNN detection algorithm may include at least one weak classifier, and different weak classifiers may have the same or different filtering strategies. The filtering strategies may include, but is not limited to, a morphological filtering strategy and/or a skin color filtering strategy. That is, the weak classifiers can use morphological filtering strategies to perform filtering, or skin color filtering strategies can also be used to perform filtering.

In addition, the weaker classifiers may be deployed on any level of network of a specific CNN detection algorithm.

In one example, using a specific CNN detection algorithm to detect a frame of input image in the input image sequence to obtain the tracking frame including the target object may include, but is not limited to, for the tracking frame of the weak classifier input to the specific CNN detection algorithm, using the weak classifier to detect whether the tracking frame meets the filtering strategy; if the filtering strategy is not met, outputting the tracking frame to a next level network of the specific CNN detection algorithm; and if the filtering strategy is met, filtering the tracking frame.

In one example, using a specific CNN detection algorithm to detect a frame of input image in the input image sequence to obtain the tracking frame including the target object may include, but is not limited to, converting the input image and network a parameter into fixed-point data (instead of floating-point data), and processing the converted fixed-point data by using the specific CNN detection algorithm to obtain the tracking frame including the target object.

In another example, the specific CNN detection algorithm may also be implemented through a fixed-point network (such as a fixed-point MTCNN network), and the input image and the network parameter in the fixed-point network may all be fixed-point data. Based on this, using a specific CNN detection algorithm to detect a frame of input image in the input image sequence to obtain the tracking frame including the target object may include, but is not limited to, processing the fixed-point data in the fixed-point network by using the specific CNN detection algorithm to obtain the tracking frame including the target object.

In one example, before using the specific CNN detection algorithm to detect a frame of input image in the input image sequence to obtain the tracking frame including the target object, the frame of the input image in the input image sequence may be preprocessed to obtain a preprocessed input image. Subsequently, the specific CNN detection algorithm may be used to process the preprocessed input image to obtain the tracking frame including the target object. The preprocessing may include, but is not limited to, a compressed sensing processing and/or a skin color detection processing.

In one example, using the specific CNN detection algorithm to detect a frame of input image in the input image sequence to obtain the tracking frame including the target object may include, but is not limited to, using time domain information to predict a reference area of the target object, and detecting the reference area in the frame of the input image in the input image sequence by using the specific CNN detection algorithm to obtain the tracking frame including the target object.

103, based on a tracking algorithm (i.e., the target object tracking frame obtained at the process at 102), tracking the target object a plurality of frames of input images behind the frame of input image (i.e., the frame of input image for detection) based on the target object tracking frame. Based on the tracking algorithm, the target object may be tracked in each frame of the input image of the plurality of frames of input images behind the frame of the input image. That is, every certain number of input images, a frame of input image may be detected (i.e., the process at 102), and tracked in a plurality frames of input images behind the frame of input image (i.e., the process at 103).

For example, the process at 102 may be used to detect the first frame of input image, and then the process at 103 may be used to track the second frame of input image to the tenth frame of input image. Subsequently, the process at 102 may be used to detect the eleventh frame of input image, and then the process at 103 may be used to track the twelfth frame of input image to the twentieth frame of input image. By analogy, the above processes at 102 and 103 cam be repeated to complete the tracking control.

In one example, based on the tracking algorithm, tracking the target object in the plurality frames of input images behind the frame of input image based on the target object tracking frame may include, but is not limited to, obtaining the tracking frame of the target object based on the input image of the previous frame and a spatial context model of the target object. In some embodiments, the spatial context model may be used to indicate the spatial correlation between the target object and the surrounding image area in the last frame of input image. Subsequently, based on the spatial context model, the target object may be determined at the position of the corresponding tracking frame in the input image of the current frame and in the surrounding area.

In one example, the spatial context model may include, but is not limited to, one or any combination of grayscale features, histogram of oriented gradient (HOG) features, moment features, and scale-invariant feature transform (SIFT) features.

In one example, based on the tracking algorithm, tracking the target object in the plurality frames of input images behind the frame of input image based on the target object tracking frame may include, but is not limited to, using a Kalman filter to predict the reference area of the target object; and based on the tracking algorithm, tracking the target object based on the reference area of the target object tracking frame in the plurality of frames of input images behind the frame of input image.

In one example, the detection algorithm may be implemented by using a first thread, and the tracking algorithm may be implemented by using a second thread. That is, the detection algorithm and the tracking algorithm may be implemented using different threads.

In one example, tracking the target object in the plurality of frames of input images behind the frame on input image based on the target object tracking frame may include, but is not limited to, outputting the target object tracking frame to the second thread by using the first thread, and then using the second thread to track the target object in the plurality of frames of input images behind the frame on input image based on the target object tracking frame.

In one example, after obtaining the target object tracking frame by detecting a frame of input image in the input image sequence, the detection of the plurality of frames of input images behind the frame of input image may be stopped by using the first thread. That is, no more detection of the plurality of frames of input images behind the frame of input image.

In one example, tracking the target object in the plurality of frames of input images behind the frame on input image based on the target object tracking frame may include, but is not limited to, activating the second thread after obtaining the tracking frame including the target object by using the first thread; and after the second thread is activated, using the second thread to track the target object in the plurality of frames of input images behind the frame on input image based on the target object tracking frame.

In one example, after the detection algorithm is activated and the current input image is the first frame of input image in the input image sequence, a first state machine may be set to an activated state by using the first thread. When the first state machine is in the activated state, the input image may be detected by using the first thread.

In some embodiments, when the detection algorithm is activated and the current input image is not the first input image in the input image sequence, the first state machine may be set to an idle state by using the first thread. When the first state machine is in the idle state, the first thread may stop detecting the input image.

In addition, when the detection algorithm is deactivated, the first state machine may be set to a deactivated state by using the first thread. When the first state machine is in the deactivated state, the detection of the input image by using the first thread may be stopped.

In addition, when the tracking algorithm is activated, a second state machine may be set to an activated state by using the second thread. When the second state machine is in the activated state, the input image may be tracked by using the second thread.

In addition, when the tracking algorithm is deactivated, the second state machine may be set to a deactivated state by using the second thread. When the second state machine is in deactivated state, the tracking of the input image by using the second thread may be stopped.

In one example, after tracking the target object in the plurality frames of input images behind the frame of input image based on the target object tracking frame based on the tracking algorithm, a first tracking frame in the first input image and a second tracking frame in the second input image may be used to determine a target tracking frame of the target object. In some embodiments, the first tracking frame may be a tracking frame including the target object obtained in the first input image based on the detection algorithm; and the second tracking frame may be a tracking frame obtained when the target object is tracked in the second input image based on the tracking algorithm. Based on the tracking algorithm, the target object may be tracked based on the target tracking frame.

In some embodiments, using the first tracking frame in the first input image and the second tracking frame in the second input image to determine the target tracking frame of the target object may include, but is not limited to, calculating the degree of overlap between the first tracking frame and the second tracking frame, and determining the target tracking frame of the target object based on the degree of overlap.

In some embodiments, determining the target tracking frame of the target object based on the degree of overlap may include, but is not limited to, determining the second tracking frame as the target tracking frame of the target object if the degree of overlap is greater than or equal to a predetermined threshold (which may be configured based on experience); and determining the first tracking frame as the target tracking frame of the target object if the degree of overlap is less than the predetermined threshold.

In some embodiments, the degree of overlap may include an intersection union ratio (IoU) between the first tracking frame and the second tracking frame.

Based on the above technical solution, in the embodiments of the present disclosure, the accuracy and reliability of face detection can be improved, network complexity and calculation amount can be reduced, real-time detection effect can be achieved, and multi-face detection can be realized. As such, the read and write overhead and CPU usage can be reduced, and there is no need to call the detection algorithm frequently, thereby reducing the frequency of network calls, reducing excessive power consumption, and improving low real-time performance when relaying entirely on the detection algorithm.

For the process at 102, based on the detection algorithm, detecting a frame of input image in the input image sequence to obtain the tracking frame including the tracking frame, in actual applications, the input image may include a plurality of target objects, that is, a plurality of tracking frames may be obtained in the process at 102. For example, in the process at 101, an input image sequence 1 may be obtained first, the input image sequence 1 may include input images 1 to 10; then an input image sequence 2 may be obtained, the input image sequence 2 may include input images 11 to 20, and so on. Each input image sequence may include ten frames of input images, and each frame of input image may include a target object.

After the input image sequence 1 is obtained, the first frame of the input image (such as the input image 1) in the input image sequence 1 may be detected based on the detection algorithm to obtain the tracking frame including the tracking frame. Subsequently, detection on the input images 2 to 10 in the input image sequence 1 may be stopped.

Further, after the input image sequence 2 is obtained, the input image 11 in the input image sequence 2 may be detected based on the detection algorithm to obtain the tracking frame including the tracking frame. Subsequently, detection on the input images 12 to 20 in the input image sequence 2 may be stopped, and so on.

To realize the detection of the input image (the following description takes the input image 1 as an example), in this embodiment, the MTCNN detection algorithm may be used to detect the input image 1 to obtain the tracking frame including the target object.

The MTCNN can use cascaded network for face detection. In conventional MTCNN includes three networks of pnet, met, and onet with increasing complexity, and its implementation process may include outputting the preprocessed input image to pnet after the input image is preprocessed, and processing the input image in pnet to obtain a plurality of candidate frames, which may be referred to as a first type of candidate frame. The first type of candidate frames may be processed by a local non-maximum suppression (NMS) method to obtain a second type of candidate frame, the second type of candidate frame may include a part of the candidate frames of the first type of candidate frame.

Next, second type of candidate frame can be output to met. After the second type of candidate frame is processed in met, a third type of candidate frame can be obtained. Subsequently, the third type of candidate frame may be processed by the local NMS method to obtain a fourth type of candidate frame, and the fourth type of candidate frame may include a part of the candidate frames in the third type of candidate frame.

Subsequently, the fourth type of candidate frame can be output to onet. After the fourth type of candidate frame is processed in onet, a fifth type of candidate frame can be obtained. Subsequently, the fifth type of candidate frame may be processed by the local NMS method to obtain a sixth type of candidate frame, and the sixth type of candidate frame may include a part of the candidate frames in the fifth type of candidate frame.

Further, the sixth type of candidate frame may be the final obtained tracking frame of each human face.

In the above MTCNN, onet is the most complex network. Its computing speed is slow, the read and write overhead is large, and the CPU overhead is large, which makes MTCNN unable to run directly on embedded devices.

Based on the above findings, the present disclosure provides a new MTCNN. The MTCNN may include pnet and met, but may not include onet. The MTCNN may include one or more weak classifiers, and each weak classifier may be deployed on any first-level network of MTCNN.

For example, after removing onet, the MTCNN may include pnet, a local NMS (hereinafter referred to as a first local NMS), met, and a local NMS (hereinafter referred to as a second local NMS) in sequence. As such, a weak classifier may be deployed before pnet, that is, the MTCNN may include a weak classifier, pnet, the first local NMS, met, and the second local NMS in sequence. Or, a weak classifier may be deployed between pnet and the first local NMS. That is, the MTCNN may include pnet, the weak classifier, the first local NMS, met, and the second local NMS in sequence. Or, the weak classifier may be deployed between met and the second local NMS. That is, the MTCNN may include pnet, the first local NMS, met, the weak classifier, and the second local NMS in sequence, which is not limited in the present disclosure. In some embodiments, the weak classifier may be deployed on any level of the MTCNN network.

Of course, the above is an example of a single weak classifier. When there are a plurality of weak classifiers, the plurality of weak classifiers may be deployed on any first-level network of MTCNN. For example, a weak classifier 1 may be deployed before pnet, and a weak classifier 2 may be deployed between met and the second local NMS. As such, the MTCNN may include the weak classifier 1, pnet, the first local NMS, met, the weak classifier 2, and the second local NMS, which is not limited in the present disclosure. In some embodiments, each weak classifier may be deployed on any first-level network of the MTCNN.

In one example, the weak classifier may be used to filter the tracking frames (i.e., the above candidate frames, which will be referred to as the candidate frames hereinafter) based on the filtering strategy, and different weak classifiers may have the same or different filtering strategies. That is, the filtering strategy may include, but is not limited to, a morphological filtering strategy and/or a skin color filtering strategy. That is, the weak classifier may filter the input candidate frames based on the morphological filtering strategy, or use the skin color filtering strategy to filter the input candidate frames.

In summary, when the input image 1 in the input image sequence 1 is detected to obtain the tracking frame including the target object, if the MTCNN includes pnet, the first local NMS, met, the weak classifier, and the second local NMS in sequence, the implementation process may include outputting the preprocessed input image 1 to pnet after the input image 1 is preprocessed, and processing the input image in pnet to obtain the first type of candidate frames. The first type of candidate frames can be processed by using the first local NMS method to obtain the second type of candidate frames, and the second type of candidate frames may include a part of the candidate frames of the first type of candidate frames. Then the second type of candidate frames can be output to met, and the second type of candidate frames can be processed in met to obtain the third type of candidate frames.

Then the third type of candidate frames can be output to the weak classifier. For each candidate frame in the third type of candidate frames, the weak classifier can detect whether the candidate frame meets the filtering strategy. If the filtering strategy is not met, the candidate frame may be regarded as the fourth type of candidate frame, and if the filtering strategy is met, the candidate frame may be filtered. As such, all candidate frames not meeting the filtering strategy may be regarded as the fourth type of candidate frames, and then the fourth type of candidate frames can be output to the next level of network of the MTCNN, that is, output to the second local NMS.

Subsequently, the fourth type of candidate frames can be processed by the second local NMS method to obtain the fifth type of candidate frames. The fifth type of candidate frames may include a part of the candidate frames of the fourth type of candidate frames. The fifth type of candidate frames may not output to onet, and each candidate frame in the fifth type of candidate frames may be a tracking frame including the target object.

In the above process, before outputting the input image 1 to pnet, the input image 1 may also be preprocessed to obtain a preprocessed input image 1, and the preprocessed input image 1 may be output to pnet. In some embodiments, the preprocessing may include, but is not limited to, compressed sensing processing and/or skin color detection processing. In addition, by performing preprocessing on the input image 1, the areas where the human face may exist may be filtered out from the input image 1, and the areas where the human face may exist may be output to pnet as the preprocessed input image 1.

In the above process, three cascade networks (such as pnet, met, and onet) are simplified into two cascade networks (such as pnet and met), thereby simplifying the complexity of the MTCNN. Subsequently, the weak classifier is used to ensure that the simplified MTCNN still maintains a good detection rage and accuracy. That is, the candidate frames are subjected to morphological filtering and/or skin color filtering through the weak classifier to eliminate the candidate frames not including a human face.

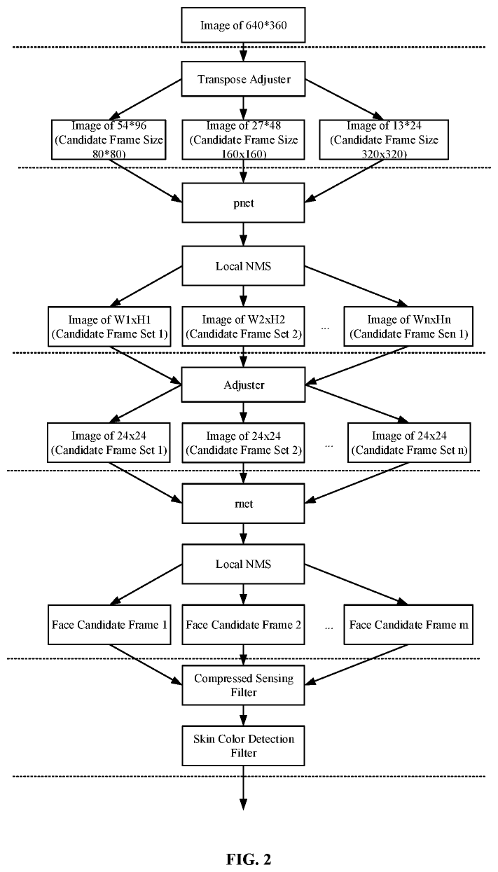

FIG. 2 is a simplified schematic diagram of the MTCNN. For the output result of met, morphological filtering and skin color filtering (such as the skin color filtering based on Haar feature) are performed in the weak classifier.

In the above process, when the MTCNN is used to detect the input image 1 in the input image sequence 1 and obtain the tracking frame including the target object, the time domain information may be used to predict the reference area of the target object (i.e., the possible area of the face in the next detection), and the prediction method is not limited in the present disclosure. Subsequently, when the MTSN is used to detect the input image 11 in the input image sequence 2 to obtain the tracking frame including the target object, the reference area in the input image 11 may be detected to obtain the tracking frame including the target object. That is, the reference area of the input image 11 is input to the MTCNN instead of the input image 11, thereby reducing the image content input to the MTCNN and improving the processing speed.

In one example, when the MTCNN is used to detect the input image 1 in the input image sequence 1 and obtain the tracking frame including the target object, a fixed-point process may be performed on all data. That is, converting the input image and network parameters (i.e., the parameters in the MTCNN) into fixed-point data, such as converting the input image and network parameters into fixed point data through a floating-point to fixed-point process (the process is not limited in the present disclosure), and convert the input image and network parameters into fixed-point data. Alternatively, a fixed-point MTCNN network may be retrained, and the input image and network parameters in the MTCNN network are fixed-point data. In this way, the fixed-point data can be processed through the MTCNN, such that all data are fixed-point data, and there is no need to perform fixed-point data conversion.

For the process at 103, the target object can be tracked in the plurality of frames of input images behind the frame of input image based on the tracking algorithm. For example, in the process at 101, an input image sequence 1 may be obtained first, the input image sequence 1 may include input images 1 to 10; then an input image sequence 2 may be obtained, the input image sequence 2 may include input images 11 to 20, and so on. Each input image sequence may include ten frames of input images, and each frame of input image may include a target object.

In the process at 102, if the tracking frame of the target object in the input image 1 is obtained, then in the process at 103, the target object may be tracked in the input images 2 to 10 in the input image sequence 1 based on the tracking algorithm and the target object tracking frame in the input image 1.

In the process at 102, if the tracking frame of the target object in the input image 11 is obtained, then in the process at 103, the target object may be tracked in the input images 12 to 20 in the input image sequence 2 based on the tracking algorithm and the target object tracking frame in the input image 11, and so on.

To realize tracking of the target object, in this embodiment, a spatio-temporal context (STC) visual tracking algorithm may be used to track the target object. More specifically, the target object tracking frame obtained based on the input image of the previous frame (i.e., the tracking frame obtained in the process at 102) and the spatial context model of the target object may be obtained. The spatial context model may be used to indicate the spatial correlation between the target object and the surrounding image area in the previous frame of the input image. Subsequently, based on the spatial context model, the target object may be determined at the positioned of the corresponding tracking frame in the input image of the current frame and in the surrounding area.

In some embodiments, the STC tracking algorithm may be a target tracking algorithm based on spatio-temporal context. The STC tracking algorithm can model the spatio-temporal relationship between the target to be tracked and the target's local context area through the Bayesian framework, and obtain the statistical correlation between the target and the features of its surrounding area. Subsequently, the spatio-temporal relationship and the focus of attention features on the biological vision system may be combined to evaluate the confidence map of the target appearing position in the new frame of image, and the position with the highest confidence may be the target position in the new frame of image. Based on the STC tracking algorithm, the target object may be tracked. The target object tracking method is not limited in the present disclosure.

For conventional STC tracking algorithm, in this embodiment, the scale transformation of the STC tracking algorithm may be simplified to reduce the complexity of the STC tracking algorithm, and this process is not limited in the present disclosure.

In one example, when using the STC tracking algorithm to track the target object, the features of the aforementioned spatial context model may include, but is not limited to, grayscale features, HOG features, moment features, and SIFT features. The type of features of the spatial context model is not limited in the present disclosure.

In one example, when using the STC tracking algorithm to track the target object, the Kalman filter may also be used to predict the reference area of the target object (i.e., predict the possible area of the face in the next tracking). The prediction method is not limited in the present disclosure. Subsequently, when using the STC tracking algorithm to track the target object in the next frame of input image, the reference area in the next frame of input image may be tracked. That is, the STC tracking algorithm may be used to track the target object in the reference area instead of tracking all areas of the input image, thereby assisting the STC tracking algorithm to update the target object position and improving the processing speed.

In the process at 101, an input image sequence 1 may be obtained first, the input image sequence 1 may include input images 1 to 10; then an input image sequence 2 may be obtained, the input image sequence 2 may include input images 11 to 20, and so on. In some embodiments, each input image sequence may include ten frames of input images.

In the process at 102, after obtaining the input image sequence 1, the input image 1 in the input image sequence 1 may be detected based on the detection algorithm to obtain a tracking frame A including the target object, but the input images 2 to 10 may not be detected. Subsequently, after obtaining the input image sequence 2, the input image 11 in the input image sequence 2 may be detected based on the detection algorithm to obtain a tracking frame B including the target object, but the input images 12 to 20 may not be tracked, and so on.

In an implementation of the process at 103, the target object may be tracked in the input images 2 to 10 based on the tracking frame A based on the tracking algorithm. Subsequently, the target object may be tracked in the input images 12 to 20 based on the track frame B based on the tracking algorithm, and so on.

In this implementation, to track the target object, the detection result of the detection algorithm (i.e., the tracking frame B) is used directly, instead of considering the previous tracking result. That is, when the target object is tracked in the input images 12 to 20, the tracking result of the input images 2 to 10 may not be considered, but the target object may be directed tracked in the input images 12 to 20 based on the tracking frame B. That is, the tracking process of the target object may be unrelated to the tracking result of input images 2 to 10.

In another implementation of the process at 103, based on the tracking algorithm, the target object may be tracked in the input images 2 to 10 based on the tracking frame A. Subsequently, the target object may be tracked continuously without stopping the tracking process. That is, each frame of input image may be tracked, such as continuing to track the target object in the input images 11 to 20, and so on.

After detecting the input image 11 and obtaining the tracking frame B, assume that the target object is currently being tracked in the input image 12, a tracking frame C may be obtained. The tracking frame B and the tracking frame C may be merged to obtain an accurate tracking frame X (the tracking frame X may be the tracking frame B or the tracking frame C). Subsequently, based on the tracking algorithm, the target object may be tracked in the input images 13 to 20 based on the tracking frame X, and so on. After each tracking frame is obtained based on the detection algorithm, the tracking frame obtained by the detection algorithm may be merged with the tracking frame obtained by the tracking algorithm to obtain an accurate tracking frame. Then, based on the tracking algorithm, the target object may be tracked in the input image based on the tracking frame.

In this implementation, to track the target object, the detection result of the detection algorithm (such as the tracking frame B) and the tracking result of the tracking algorithm (such as the tracking frame C) may be considered. That is, when tracking the target object in the input images 12 to 20, the tracking result of the input image may be considered. That is, the tracking frame B and the tracking frame C can be merged, and the target object may be tracked in the input image based on the merged result. In other words, the tracking process of the target object may be related to the tracking result of the input image.

The second implementation method described above will be described in conjunction with specific embodiments. More specifically, in this embodiment, the first tracking frame in the first input image (the tracking frame obtained in the first input image based on the detection algorithm, such as the tracking frame B described above) and the second tracking frame in the second input image (the tracking frame obtained in the second input image based on the tracking algorithm, such as the tracking frame C described above) may be used to determine the target tracking frame of the target object. Subsequently, based on the tracking algorithm, the target object may be tracked based on the target tracking frame. That is, the process at 103 may be performed based on the target tracking frame, which will not be repeated here.

In one example, using the first tracking frame in the first input image and the second tracking frame in the second input image to determine the target tracking frame of the target object may include, but is not limited to, calculating the degree of overlap (i.e., the IoU, such as the intersection of the first tracking frame and the second tracking frame, divided by the union of the first tracking frame and the second tracking frame) between the first tracking frame and the second tracking frame). If the degree of overlap is greater than or equal to the predetermined threshold, the second tracking frame may be determined as the target tracking frame. Alternatively, if the degree of overlap is less than the predetermined threshold, the first tracking frame may be determined as the target tracking frame.

In some embodiments, when the degree of overlap between the first tracking frame and the second tracking frame is greater than or equal to the predetermined threshold, it may indicate that the tracking result of the tracking algorithm is not offset, and the current tracking target remains unchanged. That is, the second tracking frame may be determined as the target tracking frame, and the tracking may be continued based on the second tracking frame. In some embodiments, when the degree of overlap between the first tracking frame and the second tracking frame is less than the predetermined threshold, it may indicate that the tracking result of the tracking algorithm is offset, or a new face is added. Therefore, the current tracking frame may be eliminated, or the tracking target may be updated to a new face. That is, the first tracking frame may be determined as the target tracking frame, and the tracking may be continued based on the first tracking frame.

In the above embodiments, the detection algorithm and the tracking algorithm may also be implemented by different threads. For example, the detection algorithm may be implemented by the first thread, and the tracking algorithm may be implemented by the second thread.

For example, after obtaining the input image sequence 1, the first thread may be used to detect the input image 1 in the input image sequence 1 based on the detection algorithm to obtain the tracking frame A including the target object, and the first thread may stop performing detection on input images 2 to 10 in the input image sequence 1.

After the obtaining the input image sequence 2, the first thread may be used to detect the input image 11 in the input image sequence 2 based on the detection algorithm to obtain the tracking frame B including the target object, and the first thread may stop performing detection on the input images 12 to 20 in the input image sequence 2, and so on.

Further, after the first thread detects the input image 1 in the input image sequence land obtains the tracking frame A including the target object, the first thread may output the tracking frame A of the target object to the second thread, such that the second thread may track the target object in the input image based on the tracking frame A of the target object. After the first thread detects the input image 12 in the input image sequence 2 and obtain the tracking frame B including the target object, the first thread may output the tracking frame B of the target object to the second thread, such that the second thread may track the target object in the input image based on the tracking frame B of the target object.

After the first thread obtained the tracking frame A including the t, the first thread may also trigger the activation of the second thread. After the second thread is activated, the second thread may track the target object in the input images 2 to 10 based on the tracking frame A of the target object. Subsequently, the second thread may track the target object in the input images 12 to 20 based on the tracking frame B of the target object, and so on.

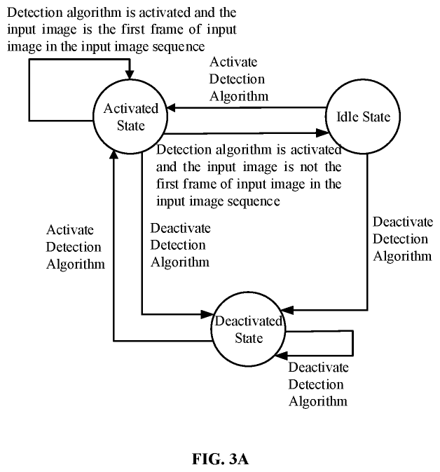

Referring to FIG. 3A and FIG. 3B, which are schematic diagrams of state machines and synchronization mechanism for the detection algorithm and the tracking algorithm. The detection algorithm and the tracking algorithm may be placed in different threads, maintain their own state machine to realize state switching, and realize state synchronization through a shared memory. The detection algorithm may be used to locate the frame coordinates of the face from the current input image (i.e., the tracking frame described above), and the tracking algorithm may be responsible for tracking the detected face frame.

In some embodiments, when the detection algorithm is activated and the current input image is the first frame of the input image sequence, the first state machine (i.e., the state machine of the detection algorithm) may be set to the activated state through the first thread. When the first state machine is in the activated state, the input image may be detected through the first thread. In addition, when the detection algorithm is activated and the current input image is not the first input image in the input image sequence, the first state machine may be set to the idle state through the first thread. When the first state machine is in the idle state, the detection of the input image may be stopped through the first thread. In addition, when the detection algorithm is deactivated, the first state machine may be set to the deactivated state through the first thread. When the first state machine is in the deactivated state, the detection on the input image may be stopped through the first thread.

Further, when the tracking algorithm is activated, the second state machine (i.e., the state machine of the tracking algorithm) may be set to the activated state through the second thread. When the second state machine is in the activated state, the input image may be tracked through the second thread. In addition, when the tracking algorithm is deactivated, the second state machine may be set to the idle state through the second thread. When the second state machine is in the deactivated state, the tracking may be stopped through the second thread.

Based on the above embodiments, in the embodiments of the present disclosure, the accuracy and reliability of face detection can be improved, network complexity and calculation amount can be reduced, real-time detection effect can be achieved, and multi-face detection can be realized. As such, the read and write overhead and CPU usage can be reduced, and there is no need to call the detection algorithm frequently, thereby reducing the frequency of network calls, reducing excessive power consumption, and improving low real-time performance when relaying entirely on the detection algorithm.

The above method is a quick multi-face detection method that combines the detection algorithm and the tracking algorithm, which can achieve real-time multi-face detection effect, quickly perform face detection, and achieve a detection speed of hundreds of frames per second.

In the above method, the MTCNN detection algorithm may be used to detect faces to improve the accuracy and robustness of face detection, thereby reducing the network complexity and calculation, reducing read and write overhead and CPU overhead, reducing the frequency of network calls, and reducing power consumption. In addition, the fixed-point conversion of network parameters and the calculation process to ensure the accuracy of fixed-point network. By simplifying the MTCNN detection algorithm and improving the fixed-point processing, the network complexity can be reduced, the amount of calculation can be reduced, and the network operations can be all converted to fixed-point operations to retain better accuracy, such that the MTCNN detection algorithm may be performed on embedded devices.

In the above method, the STC tracking algorithm with low memory and CPU overhead is introduced and merged with the detection algorithm. The STC tracking algorithm can perform most of the face detection, thereby improving the real-time performance of relying entirely on the detection algorithm. Since the detection algorithm does not need to be called frequently, the power consumption can be reduced. Since the STC tracking algorithm is added, the detection algorithm needs to play a corrective role and does not need to be called frequently, such that the power consumption on the embedded device can be controlled. Since the tracking result of the STC tracking algorithm and the detection result of the detection algorithm are combined, the offset of the STC tracking algorithm can be controlled.

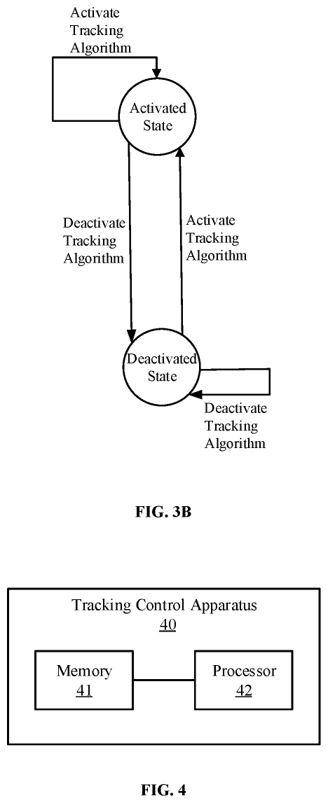

Referring to FIG. 4, based on the inventive concept similar to or the same as the above method, the present disclosure further provides a tracking control apparatus 40 including a memory 41 and a processor 42 (such as one or more processors).

In one example, the memory is used to store a computer program. The processor is used to call and execute the computer program to perform the following operations of obtaining an input image sequence; based on a detection algorithm, detecting a frame of input image in the input image sequence to obtain a tracking frame including a target object; and based on a tracking algorithm, tracking the target object a plurality of frames of input images behind the frame of input image based on the target object tracking frame.

In some embodiments, the processor may be configured to implement the detection algorithm through the first thread.

In some embodiments, the processor may be configured to implement the tracking algorithm through the second thread.

In some embodiments, the processor tracking the target object in the plurality of frames of input images behind frame of input image based on the tracking frame of the target object may include outputting the tracking frame of the target object to the second thread through the first thread; and tracking the target object in the plurality of frames of input images behind the frame of input image based on the tracking frame of the target object by using the second thread.

In one example, after detecting a frame of the input image in the input image sequence to obtain the tracking frame including the target object, the processor may be further configured to stop detecting the plurality of frames of input images behind the frame of input image by using the first thread.

In one example, the processor tracking the target object in the plurality of frames of input images behind the frame of input image based on the tracking frame of the target object may include activating the second thread after obtaining the tracking frame including the target object through the first thread; and using the second thread to track the target object in the plurality of frames of input images behind the frame of input image based on the tracking frame of the target object after the second thread is activated.

The processor may be further configured to use the first thread to set the first state machine to the activated state when the detection algorithm is activated, and the current input image is the first frame of the input image in the input image sequence; and detect the input image through the first thread when the first state machine is in the activated state.

The processor may be further configured to use the first thread to set the first state machine to the idle state when the detection algorithm is activated, and the current input image is not the first frame of the input image in the input image sequence; and stop detecting the input image through the first thread when the first state machine is in the idle state.

The processor may be further configured to use the first thread to set the first state machine to the deactivated state when the detection algorithm is deactivated; and stop detecting the input image through the first thread when the first state machine is in the deactivated state.

The processor may be further configured to use the second thread to set the second state machine to the activated state when the tracking algorithm is activated; track the input image through the second thread when the second state machine is in the activated state; use the second thread to set the second state machine to the deactivate state when the tracking algorithm is deactivated; and stop tracking the input image through the second thread when the second state machine is in the deactivated state.

In some embodiments, the processor detecting a frame of input image in the input image sequence to obtain the tracking frame including that target object based on the detection algorithm may include using a specific CNN detection algorithm to detect a frame of input image in the input image sequence to obtain the tracking frame including the target object, where the specific CNN detection algorithm may include a weak classifier.

In some embodiments, the processor using a specific CNN detection algorithm to detect a frame of input image in the input image sequence to obtain the tracking frame including the target object may include using the weak classifier to detect whether the tracking frame meets the filtering strategy for the tracking frame of the weak classifier input to the specific CNN detection algorithm; and outputting the tracking frame to the next level of network of the specific CNN detection algorithm if the tracking frame does not meet the filtering strategy. After detecting whether the tracking frame meets the filtering strategy through the weak classifier, the processor may be further configured to filter the tracking frame if the filtering strategy is met.

In some embodiments, the processor using a specific CNN detection algorithm to detect a frame of input image in the input image sequence to obtain the tracking frame including the target object may include converting the input image and the network parameters into fixed-point data, and processing the converted fixed-point data by using the specific CNN detection algorithm to obtain the tracking frame including the target object.

In one example, the specific CNN detection algorithm may be implemented by a fixed-point network, and the input image and network parameters in the fixed-point network may be all fixed-point data.

In some embodiments, the processor using a specific CNN detection algorithm to detect a frame of input image in the input image sequence to obtain the tracking frame including the target object may include using the specific CNN detection algorithm to use fixed-point data for processing the tracking frame including the target object.

In some embodiments, before using a specific CNN detection algorithm to detect a frame of input image in the input image sequence to obtain the tracking frame including the target object, the processor may be further configured to preprocess the frame of input image in the input image sequence to obtain the preprocessed input image; and processing the preprocessed input image by using a specific CNN detection algorithm to obtain the target object including the target object.

In some embodiments, the processor using a specific CNN detection algorithm to detect a frame of input image in the input image sequence to obtain the tracking frame including the target object may include using time domain information to predict the reference area of the target object; and using the specific CNN detection algorithm to detect the reference area in the frame of the input image in the input image sequence to obtain the tracking frame including the target object.

In some embodiments, the processor tracking the target object in the plurality of frames of input images behind the frame of input image based on the tracking frame of the target object based on the tracking algorithm may include obtaining the tracking frame of the target object and the spatial context model of the target object obtained based on the previous frame of input image, the spatial context model can be used to indicate the spatial correlation between the target object and the surrounding image area in the previous frame of input image; and determining the target object at the position corresponding to the tracking frame in the current frame of input image and in the surrounding area based on the spatial context model.

In some embodiments, the processor tracking the target object in the plurality of frames of input images behind the frame of input image based on the tracking frame of the target object based on the tracking algorithm may include predicting the reference area of the target object by using the Kalman filter; and, based on the tracking algorithm, tracking the target object based on the reference area in the plurality of frames of input images behind the frame of input image with the tracking frame of the target object.

In some embodiments, after tracking the target object in the plurality of frames of input images behind the frame of input image based on the tracking frame of the target object based on the tracking algorithm, the processor may be further configured to determine the target tracking frame of the target object by using the first tracking frame in the first input image and the second tracking frame in the second input image, where the first tracking frame may be a tracking frame including the target object obtained in the first input image based on the detection algorithm, and the second tracking frame may be a tracking frame obtained when tracking the target object in the second input image based on the tracking algorithm; and, based on the tracking algorithm, track the target object based on the target tracking frame.

In some embodiments, the processor determining the target tracking frame of the target object by using the first tracking frame in the first input image and the second tracking frame in the second input image may include calculating the degree of overlap between the first tracking frame and the second tracking frame; and determining the target tracking frame based on the degree of overlap. In some embodiments, the processor may be configured to determine the target tracking frame of the target object based on the degree of overlap, which may include determining the second tracking frame as the target tracking frame of the target object if the degree of overlap is greater than or equal to the predetermined threshold; or, determining the first tracking frame as the target tracking frame if the degree of overlap is less than the predetermined threshold.

Based on the inventive concept similar to or the same as the above method, the present disclosure also provides a computer-readable storage medium. The computer-readable storage medium may be configured to store a plurality of computer instructions. The computer instructions may be executed by a processor, such that the processor performs the above tracking control method, as shown in the foregoing embodiments.

The method and apparatus provided in embodiments of the present disclosure have been described in detail above. In the present disclosure, particular examples are used to explain the principle and embodiments of the present disclosure, and the above description of embodiments is merely intended to facilitate understanding the methods in the embodiments of the disclosure and concept thereof; meanwhile, it is apparent to persons skilled in the art that changes can be made to the particular implementation and application scope of the present disclosure based on the concept of the embodiments of the disclosure, in view of the above, the contents of the specification shall not be considered as a limitation to the present disclosure.

For the convenience of description, when describing the above devices, various units divided by their functions are described. When implementing the present disclosure, the functions of the various units may be realized in one or multiple software programs and/or hardware components.

A person having ordinary skills in the art can appreciate, embodiments of the present disclosure may provide a methods, a system, or a computer program product. As such, the present disclosure may include pure hardware embodiments, pure software embodiments, or a combination of both software and hardware embodiments. In addition, the present disclosure may be in a form of a computer program product implemented in one or more computer-readable storage media (including but not limited to a magnetic storage device, a CD-ROM, an optical storage device, etc.) that stores computer-executable program codes or instructions.

The present disclosure is described with reference to the flow charts or schematic diagrams of the method, device (system), and computer program product of the embodiments of the present disclosure. A person having ordinary skills in the art can appreciate, computer program codes or instructions may be used to implement each step and/or each block of the flow charts and/or the schematic diagram, and a combination of the steps and/or blocks in the flow charts and/or the schematic diagrams. The computer program codes or instructions may be provided to a generic computer, a dedicated computer, an embedded processor, or other processors that may be programmable to process data, to form a machine, or a device that can perform various functions of a step or multiple steps in the flow charts, and/or a block or multiple blocks of the schematic diagrams, based on codes or instructions executed by the computer or other processors that are programmable to process data.

Furthermore, the computer program codes may be stored in a computer-readable storage device that may guide a computer or other device that is programmable to process data to function in a specific manner, such that the codes stored in the computer-readable storage device generates a product including a code device. The code device may realize a specific function of a step or multiple steps of a flow chart, and/or a block or multiple blocks of a schematic diagram.

These computer program codes may be loaded into a computer or other device programmable to process data, such that a series of operation steps are executed on the computer or the other device programmable to process data to perform processing realized by the computer or the other device. The codes executed by the computer or other device programmable may realize specific functions of a step or multiple steps of a flow chart, and/or a block or multiple blocks of a schematic diagram.

The above described embodiments are only examples of the present disclosure, and do not limit the scope of the present disclosure. A person having ordinary skills in the art can appreciate that the present disclosure may be modified or varied. Any modification, equivalent substitution, or improvement to the described embodiments within the spirit and principle of the present disclosure, fall within the scope of the claims of the present disclosure.

What is claimed is:

1. A tracking control method, comprising:
obtaining an input image sequence;
based on a detection algorithm, detecting a frame of input image in the input image sequence to obtain a tracking frame including a target object; and
based on a tracking algorithm, tracking the target object in a plurality of frames of input images behind the frame of input image based on the tracking frame of the target object.

2. The method of claim 1, wherein:
the detection algorithm is implemented through a first thread, and the tracking algorithm is implemented through a second thread.

3. The method of claim 2, wherein tracking the target object in the plurality of frames of input images behind the frame of input image based on the tracking frame of the target object includes:
outputting the tracking frame of the target object to the second thread through the first thread; and
tracking the target object in the plurality of frames of input images behind the frame of input image by using the second thread based on the tracking frame of the target object.

4. The method of claim 2, wherein after detecting the frame of input image in the input image sequence to obtain the tracking frame including the target object, further comprising:
stopping to detect the plurality of frames of input images behind the frame of input image through the first thread.

5. The method of claim 2, wherein tracking the target object in the plurality of frames of input images behind the frame of input image based on the tracking frame of the target object includes:
activating the second thread after obtaining the tracking frame including the target object through the first thread;
tracking the target object in the plurality of frames of input images behind the frame of input image by using the second thread based on the tracking frame of the target object after the second thread is activated.

6. The method of claim 2, further comprising:
setting a first state machine to an activated state through the first thread when the detection algorithm is activated, and a current input image is a first frame of the input image in the input image sequence; and detecting the input image through the first thread when the first state machine is in the activated state;
setting the first state machine to an idle state through the first thread when the detection algorithm is activated, and the current input image is not the first frame of the input image in the input image sequence; and stopping to detect the input image through the first thread when the first state machine is in the idle state; and
setting the first state machine to a deactivated state through the first thread when the detection algorithm is deactivated; and stopping to detect the input image through the first thread when the first state machine is in the deactivated state.

7. The method of claim 2, further comprising:
setting a second state machine to an activated state through the second thread when the tracking algorithm is activated; and tracking the input image through the second thread when the second state machine is in the activated state; and
setting the second state machine to a deactivated state through the second thread when the tracking algorithm is deactivated; and stopping to track the input image through the second thread when the second state machine is in the deactivated state.

8. The method of claim 1, wherein based on the detection algorithm, detecting the frame of input image in the input image sequence to obtain the tracking frame including the target object includes:
using a specific CNN detection algorithm to detect the frame of the input image in the input image sequence to obtain the tracking frame including the target object, the specific CNN detection algorithm including a weak classifier.

9. The method of claim 8, wherein:
the specific CNN detection algorithm a MTCNN detection algorithm including pnet and met, but not onet.

10. The method of claim 8, wherein using the specific CNN detection algorithm to detect the frame of the input image in the input image sequence to obtain the tracking frame including the target object includes:
for each target object of the weak classifier input to the specific CNN detection algorithm, using the weak classifier to detect whether the tracking frame meets a filtering strategy;
outputting the tracking frame to a next level network of the specific CNN detection algorithm if the filtering strategy is not met.

11. A tracking control apparatus, comprising:
a processor; and
a memory storing one or more sets of instruction sets that, when executed by the processor, causes the processor to:
obtain an input image sequence;
based on a detection algorithm, detect a frame of input image in the input image sequence to obtain a tracking frame including a target object; and
based on a tracking algorithm, track the target object in a plurality of frames of input images behind the frame of input image based on the tracking frame of the target object.

12. The apparatus of claim 11, wherein:
the processor is configured to implement the detection algorithm through a first thread, and implement the tracking algorithm through a second thread.

13. The apparatus of claim 12, wherein the processor tracking the target object in the plurality of frames of input images behind the frame of input image based on the tracking frame of the target object includes:
outputting the tracking frame of the target object to the second thread through the first thread; and
tracking the target object in the plurality of frames of input images behind the frame of input image by using the second thread based on the tracking frame of the target object.

14. The apparatus of claim 12, wherein after detecting the frame of input image in the input image sequence to obtain the tracking frame including the target object, the processor is further configured to:
stop detecting the plurality of frames of input images behind the frame of input image through the first thread.

15. The apparatus of claim 12, wherein the processor tracking the target object in the plurality of frames of input images behind the frame of input image based on the tracking frame of the target object includes:
activating the second thread after obtaining the tracking frame including the target object through the first thread;
tracking the target object in the plurality of frames of input images behind the frame of input image by using the second thread based on the tracking frame of the target object after the second thread is activated.

16. The apparatus of claim 12, wherein the processor is further configured to:
set a first state machine to an activated state through the first thread when the detection algorithm is activated, and a current input image is a first frame of the input image in the input image sequence; and detect the input image through the first thread when the first state machine is in the activated state;
set the first state machine to an idle state through the first thread when the detection algorithm is activated, and the current input image is not the first frame of the input image in the input image sequence; and stop detecting the input image through the first thread when the first state machine is in the idle state; and
set the first state machine to a deactivated state through the first thread when the detection algorithm is deactivated; and stop detecting the input image through the first thread when the first state machine is in the deactivated state.

17. The apparatus of claim 12, wherein the processor is further configured to:
set a second state machine to an activated state through the second thread when the tracking algorithm is activated; and track the input image through the second thread when the second state machine is in the activated state; and
set the second state machine to a deactivated state through the second thread when the tracking algorithm is deactivated; and stop tracking the input image through the second thread when the second state machine is in the deactivated state.

18. The apparatus of claim 17, wherein based on the detection algorithm, the processor detecting the frame of input image in the input image sequence to obtain the tracking frame including the target object includes:
using a specific CNN detection algorithm to detect the frame of the input image in the input image sequence to obtain the tracking frame including the target object, the specific CNN detection algorithm including a weak classifier.

19. The apparatus of claim 18, wherein:
the specific CNN detection algorithm a MTCNN detection algorithm including pnet and met, but not onet.

20. The apparatus of claim 18, wherein the processor using the specific CNN detection algorithm to detect the frame of the input image in the input image sequence to obtain the tracking frame including the target object includes:
for each target object of the weak classifier input to the specific CNN detection algorithm, using the weak classifier to detect whether the tracking frame meets a filtering strategy;
outputting the tracking frame to a next level network of the specific CNN detection algorithm if the filtering strategy is not met.
